(19) United States
(12) Patent Application Publication
(10) Pub. No.: US 2015/0127394 A1
(43) Pub. Date: May 7, 2015

(54) METHOD AND SYSTEM FOR EXPRESS DIGITAL PAYMENTS IN RESTAURANTS

(71) Applicant: MASTERCARD INTERNATIONAL INCORPORATED, Purchase, NY (US)

(72) Inventors: Julianne HOGAN, New Rochelle, NY (US); Cheryl DUAY, Rye, NY (US)

(73) Assignee: MASTERCARD INTERNATIONAL INCORPORATED, Purchase, NY (US)

(21) Appl. No.: 14/533,518

(22) Filed: Nov. 5, 2014

Related U.S. Application Data
(60) Provisional application No. 61/900,076, filed on Nov. 5, 2013.

(51) Int. Cl. G06Q 10/02

(52) U.S. Cl. CPC G06Q 10/02
USPC 705/5

(57) ABSTRACT

A method for making an enhanced restaurant reservation includes: storing at least one payment profile, wherein each of the at least one payment profile includes data related to a payment account including at least a payment account number corresponding to the related payment account; displaying a list of a plurality of restaurants; receiving an indication of a specific restaurant of the plurality of restaurants; identifying a plurality of enhanced reservation options associated with the specific restaurant; displaying, by the display device, the identified plurality of enhanced reservation options; receiving at least a reservation time and/or date and at least one user reservation option corresponding to the identified plurality of enhanced reservation options; and transmitting at least a reservation identifier, the received reservation time and/or date, and the received at least one user reservation option.

### FIELD

The present disclosure relates to the enhancement of restaurant reservations and conducting of payment transactions based thereon, specifically the use facilitating of enhanced user reservation options and express digital payments in conjunction with restaurant reservations.

### BACKGROUND

It is often a goal of the restaurant industry to ensure that consumers have the most pleasant experience possible while dining in at a restaurant. A more pleasant experience for a consumer can often result in better tips, repeat business, and increased business due to consumer referrals. As a result, restaurants may often discover new ways in order to improve the consumer experience. One such innovation was the introduction of reservations. By making a reservation, a consumer can arrive at a restaurant and get seated immediately, without having to wait. Long wait times may detract from a consumer experience, and in some instances may turn away a consumer entirely. The reservation process solves this issue for consumers that make a reservation.

In an effort to make the process of making a reservation easier, some methods and systems have been developed for making reservations with restaurants electronically, such as via a website or an application program on a mobile device. However, such systems often lack the ability for consumers to provide additional information or requests regarding their reservation. For example, a consumer may make a reservation for a party of four, but may need a high chair for a small child. The consumer may go to the restaurant at the time of the reservation, but discover that no high chair is available. This may lead to a significant wait time for the consumer despite their reservation, which may result in the consumer tipping less, deciding not to return to the restaurant, or even leaving the restaurant immediately to go elsewhere.

One such reservation system enables a consumer to provide payment information at the time of the reservation. Once the reservation is fulfilled, the payment information is transmitted from the reservation service to a payment network or the restaurant for processing. Additional information may be found in U.S. patent application Ser. No. 13/571,401, entitled “Method and System for a Payment Process to Reduce Fraud,” filed on Aug. 10, 2012, to Jennifer Dogin et al., which is herein incorporated by reference in its entirety. However, a problem with the system arises as the payment information is held and transmitted by a third party service. If communication with the service is impeded or unavailable, the payment information may be unavailable. If a consumer visits the restaurant without bringing a method of payment, relying on the details provided at the time of the reservation, then the consumer may be left with a bill and no way to pay for it.

Thus, there is a need for a technical system to provide for enhanced restaurant reservations by enabling a consumer to provide for additional reservation options, including providing payment details to pay for a bill that does not rely on a third party system for provisioning of the payment details to the restaurant.

### SUMMARY

The present disclosure provides a description of systems and methods for making enhanced restaurant reservations and conducting and processing payment transactions corresponding to an enhanced reservation.

A method for making an enhanced restaurant reservation includes: storing, in a payment database, at least one payment profile, wherein each of the at least one payment profile includes data related to a payment account including at least a payment account number corresponding to the related payment account; displaying, by a display device, a list of a plurality of restaurants; receiving, by an input device, an indication of a specific restaurant of the plurality of restaurants; identifying, by a processing device, a plurality of enhanced reservation options associated with the specific restaurant; displaying, by the display device, the identified plurality of enhanced reservation options; receiving, by the input device, at least a reservation time and/or date and at least one user reservation option corresponding to the identified plurality of enhanced reservation options; and transmitting, by a transmitting device, at least a reservation identifier, the received reservation time and/or date, and the received at least one user reservation option.

A method for conducting a payment transaction includes: storing, in a reservation database of a mobile communication device, a reservation data entry, wherein the reservation data entry includes data related to a restaurant reservation including at least a reservation identifier, a specific restaurant, and a payment account number corresponding to a payment account; identifying, by a processing device, an indication of the mobile communication device being located at the specific restaurant; transmitting, by a transmitting device, at least the reservation identifier to a point of sale device associated with the specific restaurant; receiving, from the point of sale device, transaction data for a payment transaction associated with the reservation identifier; displaying, by a display device, the received transaction data; receiving, by an input device, an indication of approval of the displayed transaction data; and transmitting, by the transmitting device, at least the reservation identifier and the payment account number included in the reservation data entry to the point of sale device.

A method for processing a payment transaction includes: storing, in a database, a reservation data entry, wherein the reservation data entry includes data related to a restaurant reservation including at least a reservation time and/or date, a reservation identifier, and at least one user reservation option; receiving, by a receiving device, an indication of fulfillment of the restaurant reservation, wherein the indication includes at least a device identifier associated with a mobile communication device; receiving, by an input device, transaction data for a payment transaction associated with the restaurant reservation; transmitting, by a transmitting device, at least the transaction data and a transaction amount for the payment transaction to the mobile communication device; receiving, by the receiving device, an indication of approval from the mobile communication device, wherein the indication of approval includes at least a payment account number; generating, by a processing device, an authorization request for a payment transaction, wherein the authorization request includes at least the transaction amount and the payment account number; and transmitting, by the transmitting device, the generated authorization request for processing by a payment network.

A system for making an enhanced restaurant reservation includes a transmitting device, a payment database, a display device, an input device, and a processing device. The payment database is configured to store at least one payment profile, wherein each of the at least one payment profile includes data related to a payment account including at least a payment account number corresponding to the related payment account. The display device is configured to display a list of a plurality of restaurants. The input device is configured to receive an indication of a specific restaurant of the plurality of restaurants. The processing device is configured to identify a plurality of enhanced reservation options associated with the specific restaurant. The display device is further configured to display the identified plurality of enhanced reservation options. The input device is further configured to receive at least a reservation time and/or date and at least one user reservation option corresponding to the identified plurality of enhanced reservation options. The transmitting device is configured to transmit at least a reservation identifier, the received reservation time and/or date, and the received at least one user reservation option.

A system for conducting a payment transaction includes a reservation database, a processing device, a transmitting device, a receiving device, a display device, and an input device. The reservation database is configured to store a reservation data entry, wherein the reservation data entry includes data related to a restaurant reservation including at least a reservation identifier, a specific restaurant, and a payment account number corresponding to a payment account. The processing device is configured to identify an indication of the mobile communication device being located at the specific restaurant. The transmitting device is configured to transmit at least the reservation identifier to a point of sale device associated with the specific restaurant. The receiving device is configured to receive, from the point of sale device, transaction data for a payment transaction associated with the reservation identifier. The display device is configured to display the received transaction data. The input device is configured to receive an indication of approval of the displayed transaction data. The transmitting device is further configured to transmit at least the reservation identifier and the payment account number included in the reservation data entry to the point of sale device.

A system for processing a payment transaction includes a processing device, a database, a receiving device, an input device, and a transmitting device. The database is configured to store a reservation data entry, wherein the reservation data entry includes data related to a restaurant reservation including at least a reservation time and/or date, a reservation identifier, and at least one user reservation option. The receiving device is configured to receive an indication of fulfillment of the restaurant reservation, wherein the indication includes at least a device identifier associated with a mobile communication device. The input device is configured to receive transaction data for a payment transaction associated with the restaurant reservation. The transmitting device is configured to transmit at least the transaction data and a transaction amount for the payment transaction to the mobile communication device. The receiving device is further configured to receive an indication of approval from the mobile communication device, wherein the indication of approval includes at least a payment account number. The processing device is configured to generate an authorization request for a payment transaction, wherein the authorization request includes at least the transaction amount and the payment account number. The transmitting device is further configured to transmit the generated authorization request for processing by a payment network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for making enhanced reservations and conducting transactions based thereon in accordance with exemplary embodiments.

FIG. 2 is a block diagram illustrating the mobile device of FIG. 1 for the making of enhanced reservations and conducting of payment transactions in accordance with exemplary embodiments.

FIG. 3 is a block diagram illustrating the point of sale device of FIG. 1 for the processing of a payment transaction from an enhanced reservation in accordance with exemplary embodiments.

FIG. 4 is a flow diagram illustrating a process for the making of an enhanced restaurant reservation using the system of FIG. 1 in accordance with exemplary embodiments.

FIG. 5 is a flow diagram illustrating a process for the conducting and processing of a payment transaction using the system of FIG. 1 in accordance with exemplary embodiments.

FIGS. 6A-6E are diagrams illustrating an exemplary graphical user interface of the mobile device of FIG. 1 for making an enhanced reservation and conducting a payment transaction in accordance with exemplary embodiments.

FIG. 7 is a flow chart illustrating an exemplary method for making an enhanced reservation in accordance with exemplary embodiments.

FIG. 8 is a flow chart illustrating an exemplary method for conducting a payment transaction in accordance with exemplary embodiments.

FIG. 9 is a flow chart illustrating an exemplary method for processing a payment transaction in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Making and Processing Enhanced Reservations

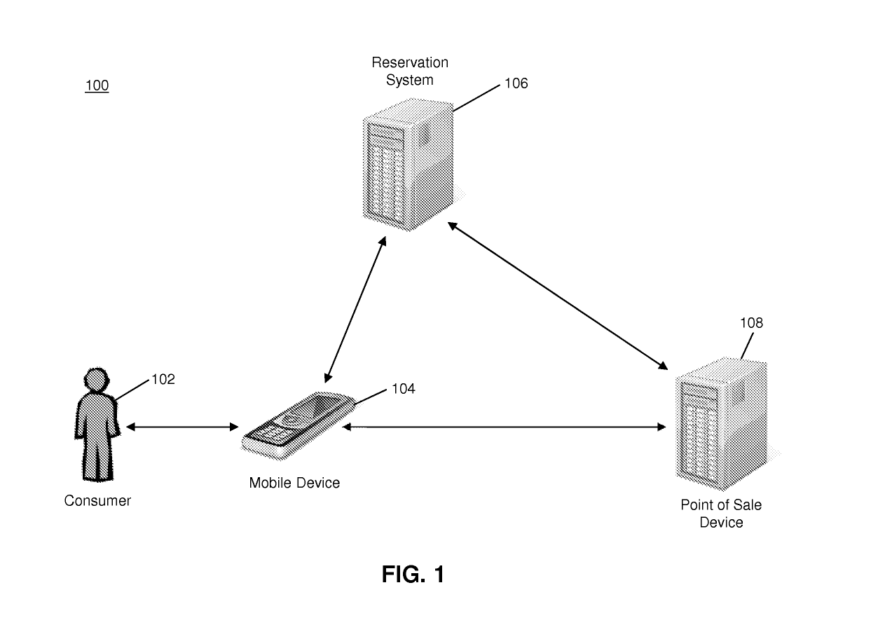

FIG. 1 illustrates a system 100 for the making of an enhanced restaurant reservation and the conducting and processing of a payment transaction based thereon.

The system 100 may include a consumer 102. The consumer 102 may possess and/or be otherwise associated with a mobile device 104. The mobile device 104 may be a mobile communication device suitable for performing the functions as disclosed herein, such as a cellular phone, smart phone, tablet computer, or other suitable device as will be apparent to persons having skill in the relevant art. The consumer 102 may use the mobile device 104 to make an enhanced reservation for a restaurant.

As discussed in more detail below, the consumer 102 may view a list of restaurants with which the consumer 102 may make a reservation using the mobile device 104. The list may be displayed via a webpage, application program, or other suitable means as will be apparent to persons having skill in the relevant art. The list of restaurants may be provided by a reservation system 106, and may be transmitted via the reservation system 106 for display to the consumer 102 or stored locally (e.g., after initial transmission by the reservation system 106) on the mobile device 104 for display when requested by the consumer 102.

The consumer 102 may select a restaurant from the list of restaurants. The mobile device 104 may then display a list of enhanced reservation options corresponding to the selected restaurant. The enhanced reservation options may include, for example, special seating options, such as requesting a booth, window, or fireplace seating, requesting a booster seat or a high chair, etc., special dining options, such as informing the restaurant that a guest has a food allergy or dietary needs, or additional amenities, such as requesting a chilled bottle of champagne to be waiting for the consumer 102 upon arrival.

The consumer 102 may select from the options and provide additional reservation details regarding the reservation, such as the reservation time and/or date and a name for the reservation. The consumer 102 may also select a payment method using the mobile device 104. The mobile device 104 may store a payment profile corresponding to a payment account, the profile including payment details for the corresponding payment account. The consumer 102 may select a payment profile corresponding to a payment account to be used to pay for the dinner corresponding to the reservation. The payment profile and corresponding payment details may be stored on the mobile device 104 in a digital wallet, in a secure element, or in any other suitable method that will be apparent to persons having skill in the relevant art. In some instances, payment may be made using reward points, reward miles, a loyalty program, etc.

Once the consumer 102 has selected payment and provided the details for the reservation, the mobile device 104 may transmit the reservation details to the reservation system 106. The reservation system 106 may then transmit the reservation details to a point of sale device 108 at the selected restaurant. In some instances, the mobile device 104 may transmit the reservation details directly to the point of sale device 108. The point of sale device 108 may store the reservation details, which may alert to employees of the upcoming reservation and to expect the consumer 102 at the reserved date and/or time and provide for any requested enhanced reservation options.

The enhanced reservation may be beneficial for both the consumer 102 and the restaurant. The consumer 102 may be able to select from a variety of options to enhance their experience at the restaurant. For example, the consumer 102 may request fireplace seating and a chilled bottle of champagne to be waiting upon arrival for a romantic dinner, or may request a booth with a booster seat and two children's menus for a family dinner. By requesting a booster seat and children's menus ahead of time, the consumer 102 can be confident that the restaurant will be prepared to accommodate them. Similarly, the restaurant may be able to estimate the resources required to serve each of its consumers ahead of time due to the reservation options. For example, the restaurant can accurately procure the number of high chairs, booster seats, etc. needed to satisfy each of its reserved parties. This may result in an overall increased consumer experience, which may, in turn, increase the economic returns of the restaurant.

At the reserved time and/or date, the consumer 102 may visit the restaurant to fulfill the reservation. Once arriving at the restaurant, the consumer 102 may check-in to the reservation using the mobile device 104. Checking-in may include identifying a geographic location of the mobile device 104 being located at the restaurant, and notifying the point of sale device 108 of the fulfillment of the reservation. Identifying the geographic location of the mobile device 104 may include using cellular network triangulation, global positioning system, detection of a local area network associated with the restaurant, reading of a machine-readable located at the restaurant, receiving an aural signal in the mobile device 104 emitted by a transmitter at the restaurant, and other suitable methods as will be apparent to persons having skill in the relevant art. The notification provided to the point of sale device 108 may include a device identifier or other suitable information for use by the point of sale device 108 in communicating with the mobile device 104.

The dining experience may then proceed for the consumer 102 in a traditional manner. Once the consumer 102 has completed their meal, an employee of the restaurant may indicate that it is time for the bill to be presented to the consumer 102 in the point of sale device 108. The point of sale device 108 may then transmit the bill to the mobile device 104, such as via a local area network or a mobile communication network. The consumer 102 may view the bill on the mobile device 104 and confirm the bill for payment using the previously selected payment method. In some instances, the consumer 102 may add a tip to the bill or provide other additional data (e.g., requesting a receipt, a takeaway box, etc.).

The mobile device 104 may transmit the approval (e.g., with the tip) including the payment details for the selected payment method to the point of sale device 108. The point of sale device 108 may then generate and submit an authorization request, including the payment details, for a payment transaction for the amount approved by the consumer 102 to a payment network for processing. The authorization request may be submitted in the same manner and format as traditional authorization requests for payment card transactions processed by the point of sale device 108. However, rather than physically scanning a payment card at the point of sale device 108, the payment details are transmitted to the point of sale device 108 from the mobile device 104. The payment details may be transmitted using a local area network, a mobile communication network, near field communication, or other suitable method as will be apparent to persons having skill in the relevant art.

Once the payment network processes the transaction, an authorization response (e.g., indicating approval or denial of the transaction) may be transmitted to the point of sale device 108. The point of sale device 108 may forward the response, or a notification indicating the response, to the mobile device 104. The consumer 102 may then view the response as displayed on the mobile device 104. In such an instance, the consumer 102 may be presented with the bill, may pay the bill, and may receive a receipt (e.g., with the forwarded response and/or notification) using the mobile device 104 without the need to use a payment card and without additional interaction with an employee of the restaurant.

Conducting and processing the payment transaction using the mobile device 104 and point of sale device 108 may be beneficial as the transaction may be completed with minimal interaction between the consumer 102 and wait staff. This may allow for the wait staff to turn their attention to other diners that are still needing assistance, and may also allow for the consumer 102 to finish their dining experience as quickly as they desire. In addition, the transaction may also be processed without the consumer 102 having to be in physical possession of cash or a payment card. This may result in less opportunity for fraud, which may increase consumer security at the restaurant and thereby further enhancing the consumer's dining experience.

### Mobile Device

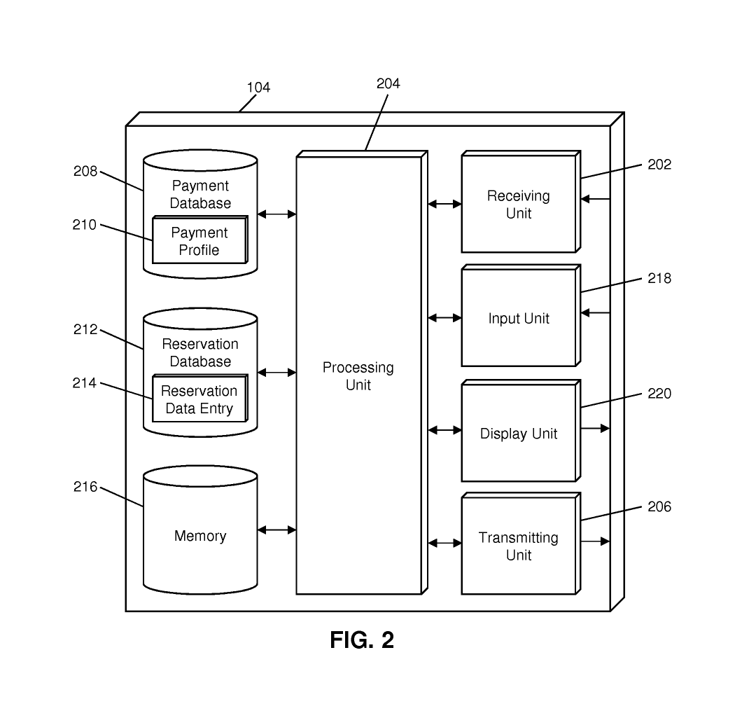

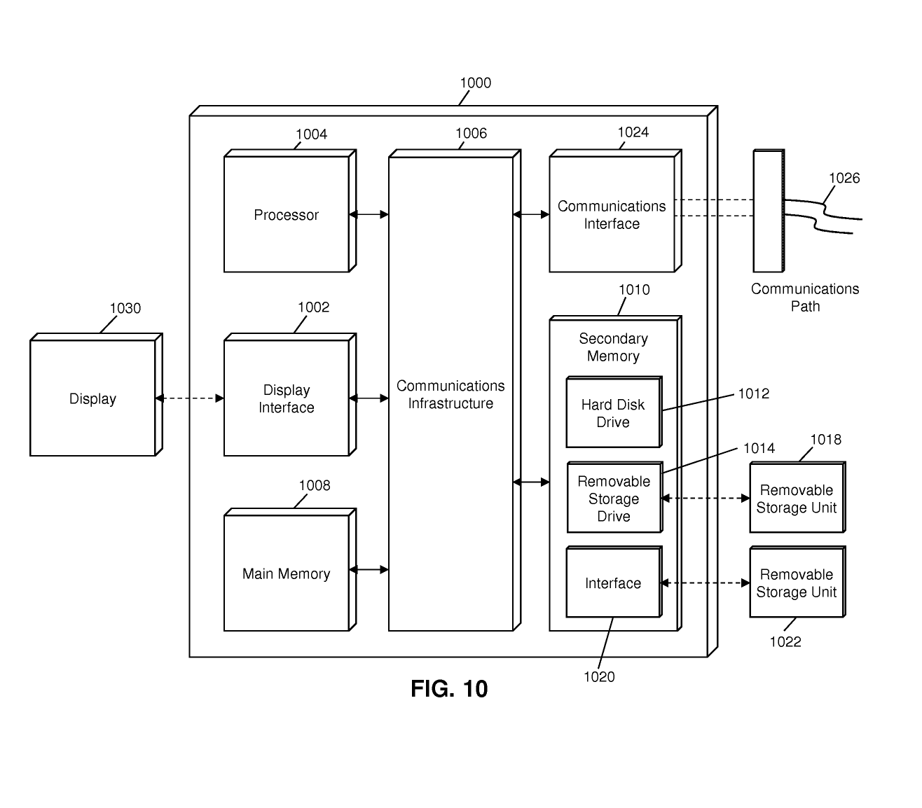

FIG. 2 illustrates an embodiment of the mobile device 104 of the system 100. It will be apparent to persons having skill in the relevant art that the embodiment of the mobile device 104 illustrated in FIG. 2 is provided as illustration only and may not be exhaustive to all possible configurations of the mobile device 104 suitable for performing the functions as discussed herein. For example, the computer system 1000 illustrated in FIG. 10 and discussed in more detail below may be a suitable configuration of the mobile device 104.

The mobile device 104 may include a receiving unit 202. The receiving unit 202 may be configured to receive data over one or more networks via one or more network protocols. The receiving unit 202 may be configured to receive restaurant information from the reservation system 106, including the list of restaurants and enhanced reservation options associated with a selected restaurant. The receiving unit 202 may also be configured to receive transaction data for a payment transaction, as well as a receipt or notification of completion of the payment transaction. The transaction data may include an itemization of items ordered while at the restaurant.

The mobile device 104 may further include an input unit 218. The input unit 218 may be configured to receive input from the consumer 102 and may include a keyboard, mouse, click wheel, touch screen, capacitive touch display, camera, microphone, or other suitable input type or device as will be apparent to persons having skill in the relevant art. The input unit 218 may be configured to receive input from the consumer 102 selecting a restaurant from the list of restaurants and selecting reservation details including a payment profile and at least one enhanced reservation option. The input unit 218 may be further configured to receive input indicating approval of a payment transaction including any additionally selected options, such as a tip amount.

The mobile device 104 may further include a display unit 220. The display unit 220 may be configured to display data to the consumer 102 and may include a liquid crystal display (LCD), a light-emitting diode (LED) display, a capacitive touch display, or any other suitable display type as will be apparent to persons having skill in the relevant art. The display unit 220 may be configured to display the list of restaurants, enhanced reservation options, reservation details, payment methods, transaction data, and authorization response and/or notification, as well as any additional data as will be apparent to persons having skill in the relevant art.

The mobile device 104 may also include a payment database 208. The payment database 208 may be configured to store one or more payment profiles 210. Each payment profile 210 may include data related to a payment account including at least a payment account number corresponding to the related payment account. The payment profile 210 may further include any additional data associated with the payment account that may be suitable for performing the functions as disclosed herein as will be apparent to persons having skill in the relevant art, such as a security code, cryptogram, expiration date, name, billing address, billing zip code, etc. The payment profile 210 may further include a name or other suitable identifier, such as for use by the consumer 102 in identifying a payment profile for selection in attaching to a reservation.

The mobile device 104 may be further configured to include a reservation database 212. The reservation database 212 may include one or more reservation data entries 214. Each reservation data entry 214 may include data corresponding to an enhanced reservation made by the consumer 102 including the reservation details, such as the reservation time and/or date, the selected enhanced reservation options, and the selected payment profile.

The mobile device 104 may further include a memory 216. The memory 216 may be configured to store any additional data for use by the mobile device 104 as will be apparent to persons having skill in the relevant art. For instance, the memory 216 may store program code for a digital wallet application program for the storage and/or managing of the payment profiles 210 in the payment database 208. In another instance, the memory 216 may include program code for an application program used to make the enhanced reservations. The program code may be executed by a processing unit 204, also included in the mobile device 104.

The processing unit 204 may be configured to execute program code stored in the memory 216, to identify data received by the receiving unit 202 and the input unit 218, identify data for display by the display unit 220, and for storing data in the payment database 208 and reservation database 212. The processing unit 204 may be further configured to coordinate data among the other various units and storage media included in the mobile device 104 and perform additional processing functions as disclosed herein as will be apparent to persons having skill in the relevant art.

The mobile device 104 may also include a transmitting unit 206. The transmitting unit 206 may be configured to transmit data over one or more networks via one or more network protocols. The transmitting unit 206 may be configured to transmit a request for enhanced reservation options to the reservation system 106, reservation details to the reservation system 106, and payment details and approval of transaction data to the point of sale device 108. The transmitting unit 206 may be further configured to transmit additional information as will be apparent to persons having skill in the relevant art, such as a rating or comments for a restaurant following completion of the consumer's dining experience.

### Point of Sale Device

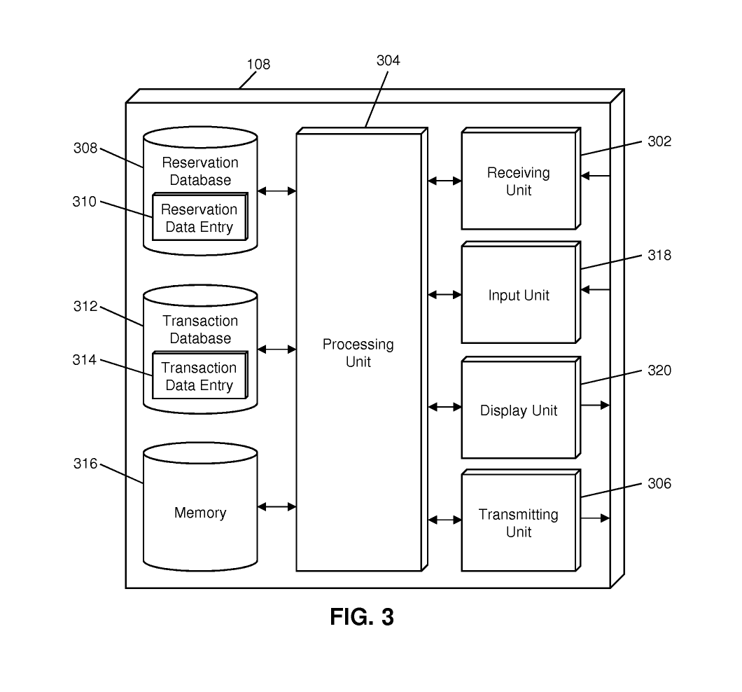

FIG. 3 illustrates an embodiment of the point of sale device 108 of the system 100. It will be apparent to persons having skill in the relevant art that the embodiment of the point of sale device 108 illustrated in FIG. 3 is provided as illustration only and may not be exhaustive to all possible configurations of the point of sale device 108 suitable for performing the functions as discussed herein. For example, the computer system 1000 illustrated in FIG. 10 and discussed in more detail below may be a suitable configuration of the point of sale device 108.

The point of sale device 108 may include a receiving unit 302. The receiving unit 302 may be configured to receive data over one or more networks via one or more network protocols. The receiving unit 302 may be configured to receive reservation details from the reservation system 106, corresponding to the enhanced reservation made by the consumer 102. The receiving unit 302 may be further configured to receive an indication of fulfillment of the reservation from the mobile device 104, reservation system 106, or other entity (e.g., a mobile network operator associated with the mobile device 104). The receiving unit 302 may also receive a transaction approval from the mobile device 104 approving a payment transaction and/or including a tip amount.

The point of sale device 108 may also include a reservation database 308. The reservation database 308 may include a plurality of reservation data entries 310. Each reservation data entry 310 may include data related to an enhanced restaurant reservation, including the reservation details and select user reservation options. The reservation data entry 310 may also include a device identifier associated with the mobile device 104, such as received in the indication of fulfillment received by the receiving unit 302.

The point of sale device 108 may further include an input unit 318. The input unit 318 may be configured to receive input from an employee of the restaurant or other suitable entity and may include a keyboard, mouse, click wheel, touch screen, capacitive touch display, camera, microphone, or other suitable input type or device as will be apparent to persons having skill in the relevant art. The input unit 318 may be configured to receive input from an employee such as items ordered by the consumer 102 and input updating the status of the consumer's dining experience. For example, the employee may input using the input unit 318 to indicate when the consumer 102 has completed their meal and requested payment of the bill.

The point of sale device 108 may also include a transaction database 312. The transaction database 312 may be configured to store one or more transaction data entries 314. Each transaction data entry 314 may include data related to a transaction being conducted (e.g., an ongoing dining experience) at the restaurant. The transaction data entry 314 may include transaction data corresponding to the related transaction, such as an itemization of products ordered by the party corresponding to the transaction, a total transaction amount, and a status of the meal. In some embodiments, the point of sale device 108 may include a single database and the data entries included therein may include the data included in both the reservation data entries 310 and transaction data entries 314 corresponding to a single reservation and/or transaction.

The point of sale device 108 may further include a display unit 320. The display unit 320 may be configured to display data to employees of the restaurant and may include a liquid crystal display (LCD), a light-emitting diode (LED) display, a capacitive touch display, or any other suitable display type as will be apparent to persons having skill in the relevant art. The display unit 320 may be configured to display reservation details included in reservation data entries 310, transaction data included in the transaction data entries 314, and transactions statuses for ongoing transactions being conducted in the restaurant. The display unit 320 may be further configured to display additional data as will be apparent to persons having skill in the relevant art.

The point of sale device 108 may also include a processing unit 304. The processing unit 304 may be configured to perform processing functions of the point of sale device 108 as disclosed. For example, the processing unit 304 may be configured to calculate a total transaction amount for a transaction based on transaction data included in the transaction data entry 314, such as selected product amounts and prices. The processing unit 304 may also be configured to calculate a total transaction amount based on a predetermined tax rate and a tip amount that may be received with a transaction approval from the mobile device 104. The processing unit 304 may also be configured to generate an authorization request for a payment transaction for the calculated transaction amount and including payment details received from the mobile device 104. Additional functions performed by the processing unit 304 will be apparent to persons having skill in the relevant art.

The point of sale device 108 may also include a transmitting unit 306. The transmitting unit 306 may be configured to transmit data over one or more networks via one or more network protocols. The transmitting unit 306 may be configured to transmit transaction data to the mobile device 104, an authorization request to a payment network for processing, and an authorization response or notification of an authorization response to the mobile device 104, and a receipt and/or any other additional data regarding a reservation and/or payment transaction to the mobile device 104.

The point of sale device 108 may also include a memory 316. The memory 316 may include any additional data used in performing the functions as disclosed herein as well as traditional point of sale system functions. For example, the memory 316 may include product data for a plurality of products offered by the restaurant. The memory 316 may also include program code for an application program, such as a restaurant management or point of sale processing program, that may be executed by the processing unit 304.

### Process for Making an Enhanced Reservation

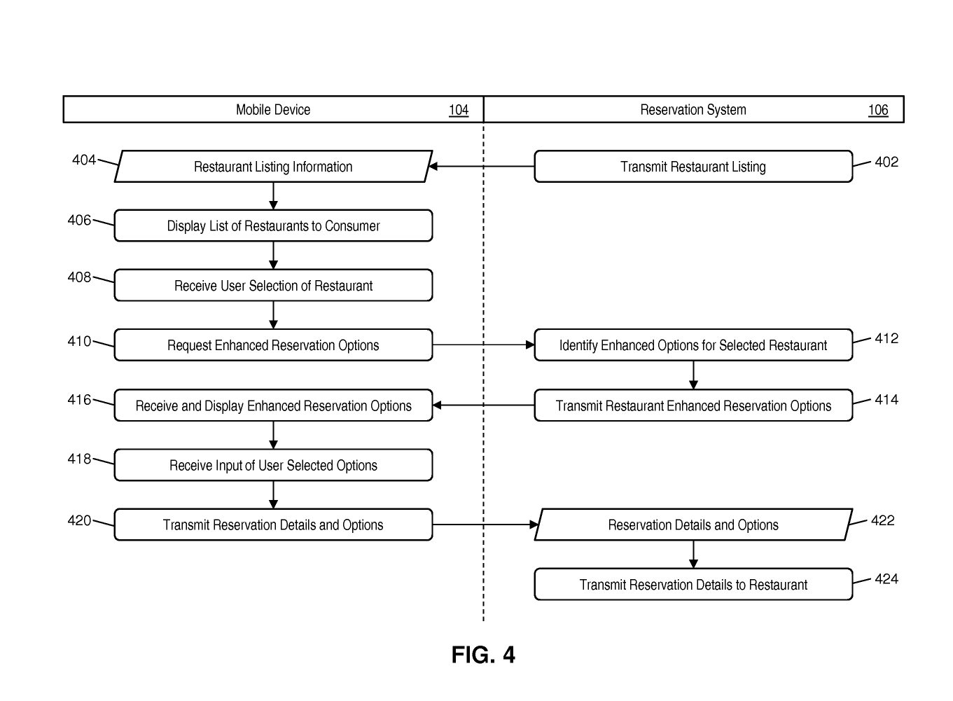

FIG. 4 illustrates a process for the making of an enhanced reservation using the mobile device 104 of the system 100 of FIG. 1.

In step 402, the reservation system 106 may transmit a list of restaurants with which the consumer 102 may make a reservation to the mobile device 104. In step 404, the mobile device 104 may receive, by the receiving unit 202, the restaurant listing information. In step 406, the display unit 220 of the mobile device 104 may display the list of restaurants to the consumer 102 for selection. In step 408, the consumer 102 may select, using the input unit 218 of the mobile device 104, a restaurant for which a reservation is to be made.

In step 410, the processing unit 204 may identify the selected restaurant and may generate a request for enhanced reservation options including information identifying the selected restaurant. The transmitting unit 206 may then transmit the request for enhanced reservation options to the reservation system 106. In step 412, the reservation system 106 may receive the request and identify enhanced reservation options associated with the selected restaurant. In step 414, the reservation system 106 may transmit the enhanced reservation options for the restaurant to the mobile device 104.

The receiving unit 202 of the mobile device 104 may receive the enhanced reservation options, in step 416, which may then be displayed to the consumer by the display unit 220. The consumer 102 may select, in step 418, one or more user reservation options, corresponding to potential enhanced reservation options for the restaurant, via the input unit 218. The consumer 102 may also select additional reservation details, including a reservation time and/or date and a reservation identifier. The reservation identifier may be a name, a device identifier associated with the mobile device 104, or other suitable value for the identification of the consumer 102 for fulfillment of the reservation.

In some instances, step 418 may also include the selection of a payment profile 210 stored in the payment database 208. In instances where the payment database 208 may only include a single payment profile 210, selection by the consumer 102 may not be required. In some embodiments, the consumer 102 may be required to provide authentication information, such as a personal identification number (PIN) prior to selection of a payment profile 210. Payment profiles 210 may be managed by a digital wallet application program (e.g., stored in the memory 216), such as MasterPass™ by MasterCard® or other suitable method as will be apparent to persons having skill in the relevant art. In some instances, the payment profile 210 may be for a loyalty or reward program, such as for using reward points for payment. In a further instance, a loyalty or reward program may be presented in addition to another payment profile 210, such as to receive reward credit while paying with a credit card.

In step 420, the transmitting unit 206 may transmit the selected reservation details including the at least one user selected option to the reservation system 106. In an exemplary embodiment, the transmitted reservation details may not include the selected payment profile 210. In some instances, the processing unit 204 may generate and store a new reservation data entry 214 in the reservation database 212 corresponding to the reservation.

In step 422, the reservation system 106 may receive the reservation details and user selected options. The reservation system 106 may, in some instances, store the reservation details. In step 424, the reservation system 106 may transmit the reservation details, including the at least one user selected option, to the point of sale device 108 of the selected restaurant. The point of sale device 108 may then store the reservation details (e.g., in the reservation database 308) and expect the consumer 102 at the corresponding date and/or time.

In some instances, the reservation system 106 may request confirmation of a requested time and/or date for the reservation from the point of sale device 108 prior to completing the process illustrated in FIG. 4. In such an instance, the point of sale device 108 may first confirm the requested date and/or time of the reservation as requested by the consumer 102 (e.g., by verifying that there is availability at that date and/or time) and may notify the reservation system 106 that the reservation may be made. The point of sale device 108 may then make the reservation, and the reservation system 106 may transmit a notification to the mobile device 104 indicating that the reservation was successfully made. If there is no availability for the requested reservation, reservation system 106 may notify the mobile device 104 accordingly, and may prompt the consumer 102 to select an alternative date and/or time. Additional steps that may be performed in the process of confirming and making a reservation will be apparent to persons having skill in the relevant art.

### Process for Conducting and Processing an Enhanced Reservation Transaction

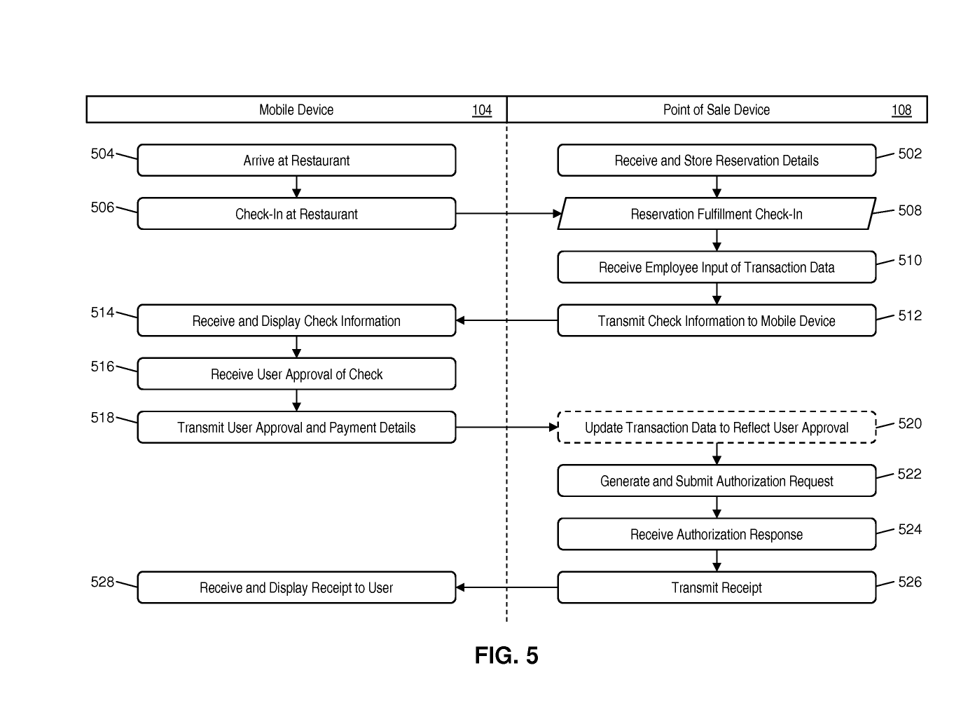

FIG. 5 illustrates a process for the conducting and processing of a payment transaction corresponding to an enhanced reservation made using the system 100 of FIG. 1, such as an enhanced reservation made using the process illustrated in FIG. 4 and discussed above.

In step 502, the point of sale device 108 may receive reservation details and at least one user selected option corresponding to an enhanced reservation option, and may store the information in a reservation data entry 310 of the reservation database 308. The reservation details may include a reservation time and/or date and a reservation identifier. In step 504, the mobile device 104 may arrive (e.g., as carried by the consumer 102) at the restaurant. In step 506, the mobile device 104 may check-in at the restaurant.

Checking-in at the restaurant may include identification of a geographic location of the mobile device 104 as being at a location corresponding to the restaurant. For example, the mobile device 104 or a mobile network operator associated with the mobile device 104 may identify a geographic location of the mobile device 104 using cellular network triangulation or the global positioning system. The identified geographic location, which may be represented by latitude and longitude, street address, or other suitable format, may correspond to a geographic location associated with the restaurant. For example, the geographic location of the mobile device 104 may be the street address of the restaurant. Additional methods for identifying the geographic location of the mobile device 104 will be apparent to persons having skill in the relevant art and include detection of a local area network associated with the restaurant, reading of a machine-readable code displayed at the restaurant, or receipt of an aural signal emitted by a transmitter located at the restaurant.

In some instances, the consumer 102 may check-in with an employee of the restaurant, and the employee may indicate fulfillment of the reservation directly in the point of sale device 108. In one embodiment, the point of sale device 108 may transmit an indication of the successful check-in by the consumer 102 to the mobile device 104, such as by using a device identifier included in the reservation data entry 310 or supplied by the consumer 102 upon check-in. The device identifier may be a phone number, media access control address, registration number, identification number, username, or other suitable identifier as will be apparent to persons having skill in the relevant art.

In step 508, the point of sale device 108 may receive, by the receiving unit 302, an indication of the fulfillment of the reservation by the mobile device 104 and/or consumer 102. In step 510, the point of sale device 108 may receive, via the input unit 318, transaction data for a payment transaction corresponding to the reservation. The transaction data may include an itemization of products ordered by the consumer 102. The transaction data may also include a transaction amount, which may be input via the input unit 318 or calculated via the processing unit 304. Methods for inputting itemized transaction data and calculation of a transaction amount thereof in a point of sale device will be apparent to persons having skill in the relevant art.

In step 512, the employee may input, via the input unit 318, an indication that the consumer 102 is ready to be presented with the check for the meal. The processing unit 304 may identify the transaction data corresponding to the meal and may transmit, via the transmitting unit 306, the transaction data to the mobile device 104. In step 514, the receiving unit 202 of the mobile device 104 may receive the transaction data, which may then be displayed, via the display unit 220, to the consumer 102.

In step 516, the input unit 218 of the mobile device 104 may receive approval of the transaction from the consumer 102. In some instances, the user approval may also include a tip amount, coupon data, receipt preferences, comments, or other additional information as will be apparent to persons having skill in the relevant art. Once the user has approved the transaction, the processing unit 204 may identify, in the corresponding reservation data entry 214, the payment profile 210 selected for funding of the payment transaction. The processing unit 204 may then identify at least the payment account number included in the selected payment profile 210 as stored in the payment database 208.

In step 518, the transmitting unit 206 may transmit the user approval, the identified payment details, and any additional data or information to the point of sale device 108. The point of sale device 108 may receive the data, using the receiving unit 302, and may, in step 520, calculate, by the processing unit 304, an updated transaction amount or otherwise update the transaction data to reflect the data and information included in the user approval. It will be apparent to persons having skill in the relevant art that step 520 may be an optional step.

In step 522, the processing unit 304 of the point of sale device 108 may generate an authorization request for the payment transaction including the transaction amount as reflected in the transaction data and the payment details received in the user approval. The transmitting unit 306 may transmit the request to a payment network for processing. In some instances, the transmitting unit 306 may transmit the transaction data and payment details to an acquirer or other entity for generation and submission of an authorization request on behalf of the point of sale device 108. The transaction may then be processed using methods and systems that will be apparent to persons having skill in the relevant art.

In step 524, the receiving unit 302 of the point of sale device 108 may receive an authorization response indicating approval or denial of the payment transaction. In instances where the payment profile 210 may be for a reward or loyalty program, steps 522 and 524 may be performed by the point of sale device 108, which may be configured to process the transaction using reward points or other loyalty currency. In some instances, steps 522 and 524 may be performed by an external network and/or entity using reward points. In step 526, the transmitting unit 306 may transmit a notification to the mobile device 104 indicating the received authorization response, such as the transmission of a receipt to the mobile device 104 for the meal if the transaction was approved. In step 528, the receiving unit 202 of the mobile device 104 may receive the receipt and/or indication of the authorization response and may display, via the display unit 220, the received data to the consumer 102.

In some embodiments, the display unit 220 of the mobile device 104 may also display additional data to the consumer 102. For example, the display unit 220 may display a request for the consumer 102 to provide a rating and/or comments as to the meal, overall dining experience, service, or other aspect of the payment transaction with the restaurant. In some instances, the information may be requested by the reservation system 106, point of sale device 108, or other third party. In some embodiments, the consumer 102 may also be prompted to provide ratings or comments throughout the dining experience, such as based on status updates to the transaction as entered by the employee into the point of sale device 108.

For example, the employee may update the transaction status for the transaction to indicate that appetizers selected by the consumer 102 have been delivered to the consumer 102. The transmitting unit 306 may transmit an indication of the status to the mobile device 104, which may then display a prompt requesting rating of the appetizers. Additional detail regarding consumer ratings and social network interaction throughout a dining experience may be found in U.S. patent application Ser. No. 13/710,922, entitled “Method and System for Sharing and Distributing Content During a Consumer Experience,” filed Dec. 11, 2012, to German Blanco et al., which is herein incorporated by reference in its entirety.

### Graphical User Interface

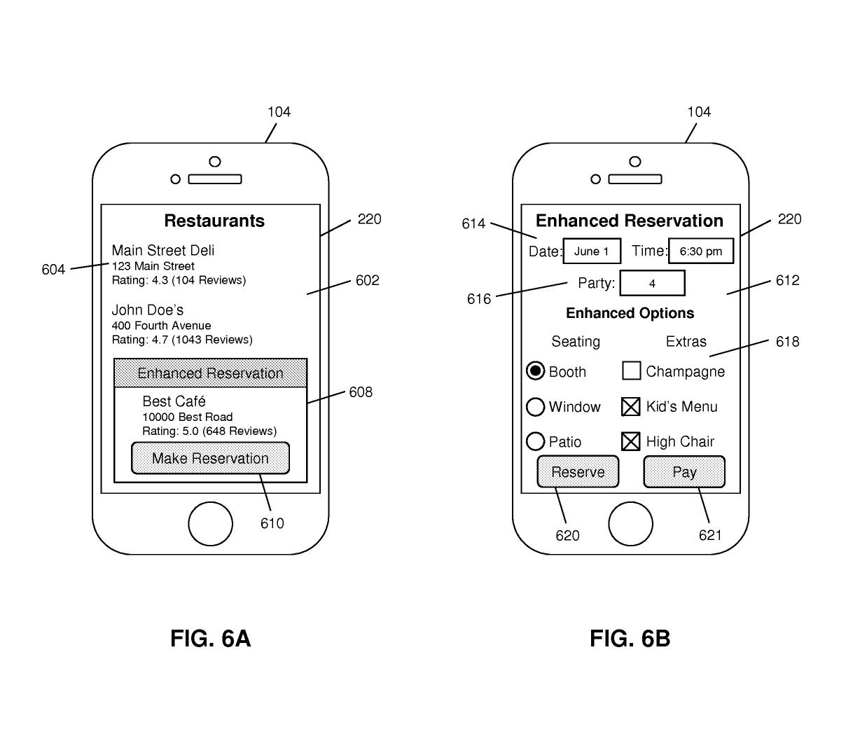

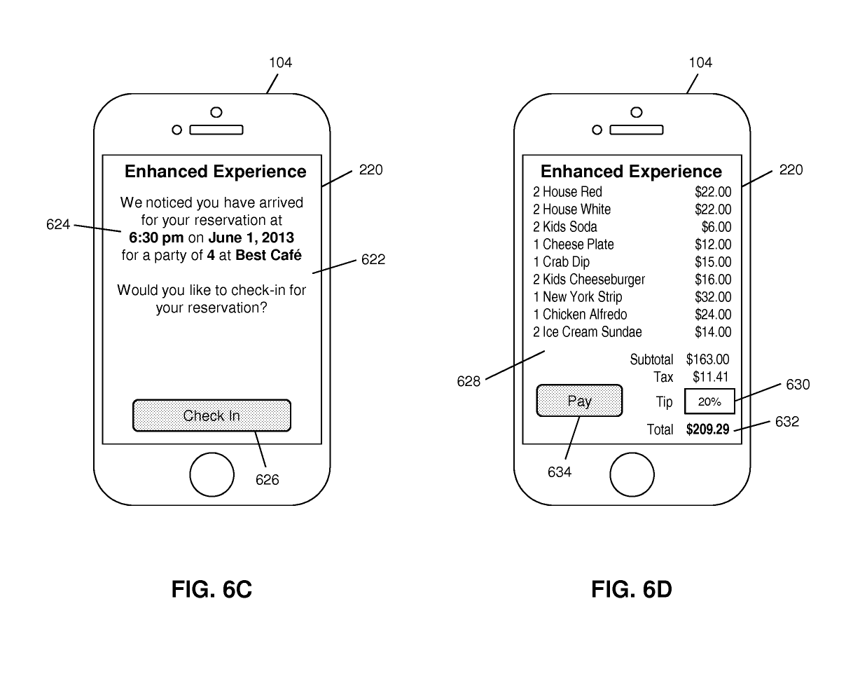

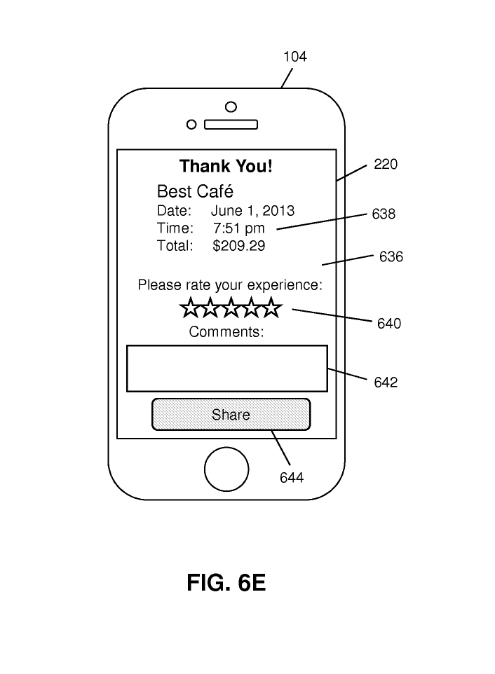

FIGS. 6A-6E illustrate an exemplary graphical user interface of the mobile device 104 for the making of enhanced reservations and conducting of payment transactions based thereon. It will be apparent to persons having skill in the relevant art that the interfaces illustrated in FIGS. 6A-6E and discussed herein are provided as an illustration only, and that additional interfaces and configurations may be available.

As illustrated in FIG. 6A, the consumer 102 may begin the processing for making an enhanced reservation via a restaurant selection screen 602, displayed via the display unit 220 of the mobile device 104. As discussed herein, the screens illustrated in FIGS. 6A-6E may be displayed via an application program (e.g., stored in the memory 216 and executed by the processing unit 204.

The restaurant selection screen 602 may include a list of restaurants 604. Each restaurant 604 may include data associated with the restaurant for viewing by the consumer 102, such as an address and rating information as illustrated in FIG. 6A. Restaurants that have the ability for an enhanced reservation may be highlighted as an enhanced restaurant 608. In some instances, each restaurant 604 may have the ability of enhanced reservation. In such an instance, the box 608 may be displayed upon selection of a particular restaurant.

The restaurant selection screen 602 may also include a make reservation button 610, which may be associated with the enhanced restaurant 608. In some instances, each restaurant 604 displayed in the list may include an associated make reservation button 610. When the consumer 102 interacts with the make reservation button 610, the mobile device 104 may request enhanced reservation options regarding the selected restaurant from the reservation system 106. The display unit 220 may then display a reservation details screen 612, as illustrated in FIG. 6B.

The reservation details screen 612 may be used by the consumer 102 to supply additional reservation details regarding the enhanced reservation. The reservation details screen 612 may include a time and/or date entry 614, which may enable the consumer 102 to select the time and/or date requested for the reservation. The reservation details screen 612 may also include a party entry 616, which may indicate the number of persons for which the reservation is requested. Additional standard reservation information that may be supplied by the consumer 102 will be apparent to persons having skill in the relevant art.

The reservation details screen 612 may also include enhanced reservation options 618. The enhanced reservation options 618 may include a plurality of options that may be selected by the consumer 102 to enhance their dining experience. The enhanced reservation options 618 may include, as illustrated in FIG. 6B, seating options (e.g., preference among booth, window, or patio seating) and additional extras for the meal, such as champagne or if a children's menu and/or high chair is needed. Additional enhanced reservation options may further include chair preferences, seating area preferences, celebration preferences, selection of food ahead of time (e.g., for items that have long cooking times). Options may also include identifying dietary restrictions or food allergies, which may alert the restaurant to provide alternative menu items and/or prepare for the preparation of food items for the consumer 102 to avoid contamination in the event of a food allergy.

The reservation details screen 612 may also include a reserve button 620. The reserve button 620 may, once interacted with by the consumer 102, submit the reservation details and user selection option or options to the reservation system and/or point of sale device 108. In some embodiments, the reservation details screen 612 may also include a payment profile selection, which may enable the consumer 102 to select a payment profile 210 for use in funding the payment transaction corresponding to the reservation. In some instances, the application program may utilize a default payment profile 210 if no profile is selected via the reservation details screen 612.

In some instances, the reservation details screen 612 may also include a pay button 621. The pay button 621, when interacted with by the consumer 102, may enable the consumer 102 to provide payment details for payment for the corresponding reservation ahead of time, such as by selecting a payment profile 210 used for payment.

Once the consumer 102 has arrived at the restaurant (e.g., based on identification of the geographic location of the mobile device 104, as discussed above), the mobile device 104 may prompt the consumer 102 to check-in for the reservation via a check-in screen 622 illustrated in FIG. 6C. The check-in screen 622 may include a message 624 indicating to the consumer 102 that the mobile device 104 has identified that the consumer 102 is in a position to fulfill the reservation. As illustrated in FIG. 6C, the message 624 may notify the consumer 102 of the reservation details and may request that the user formally check-in to the reservation.

The check-in screen 622 may include a check in button 626. The check in button 626, when interacted with by the consumer 102, may trigger the transmitting unit 206 of the mobile device to transmit a check-in notification to the point of sale device 108. The consumer 102 may then proceed with their dining experience. Once the consumer 102 has completed their meal and requested the check, the point of sale device 108 may transmit (e.g., following instruction by an employee), transaction data for the payment transaction to the mobile device 104.

The mobile device 104 may receive the transaction data and display the data to the consumer 102 via a transaction screen 628, illustrated in FIG. 6D. The transaction screen 628 may show an itemization of the items ordered during the meal corresponding to the reservation. It may also show calculated transaction amounts, such as a subtotal of the items as well as the tax amount. The transaction screen 628 may also include a tip field 630. In some instances, the tip field 630 may enable the consumer 102 to type in the exact currency amount of a tip. In other instances, such as the instance illustrated in FIG. 6D, the tip field 630 may enable the consumer 102 to select a tip percentage, and the corresponding tip amount may be calculated (e.g., by the processing unit 204) accordingly.

The transaction screen 628 may further include a pay button 634. The pay button 634, when interacted with by the consumer 102, may initiate transmission of the user approval of the transaction, including the payment details and the tip amount, to the point of sale device 108. The point of sale device 108 may then process the transaction accordingly. Once the transaction has been processed and approved, the point of sale device 108 may transmit a notification to the mobile device 104 indicating the successful processing of the transaction. The mobile device 104 may convey the information to the consumer 102 via a notification screen 636.

As illustrated in FIG. 6E, the notification screen 636 may include transaction details 638. The transaction details 638 may include relevant information for review by the consumer 102 regarding the processed transaction, such as the time, date, and processed transaction amount as illustrated in FIG. 6E. The notification screen 636 may also include a rating field 640 and comment field 642. The rating field 640 and comment field 642 may be editable by the consumer 102 in order for the consumer 102 to provide feedback to the restaurant or to other consumers (e.g., via the reservation system 106) regarding the dining experience. The notification screen 636 may also include a share button 644, which may initiate transmission of the rating and comments to the corresponding entity.

In some instances, the notification screen 636 may include multiple rating fields 640 and/or comment fields 642. For example, a rating field 640 may be included for each food item ordered by the consumer 102. The notification screen 636 may also include additional buttons and/or features that will be apparent to persons having skill in the relevant art, such as buttons for sharing on a social network, for generating a full receipt, for sending receipt information to an e-mail, etc.

### Exemplary Method for Making an Enhanced Reservation

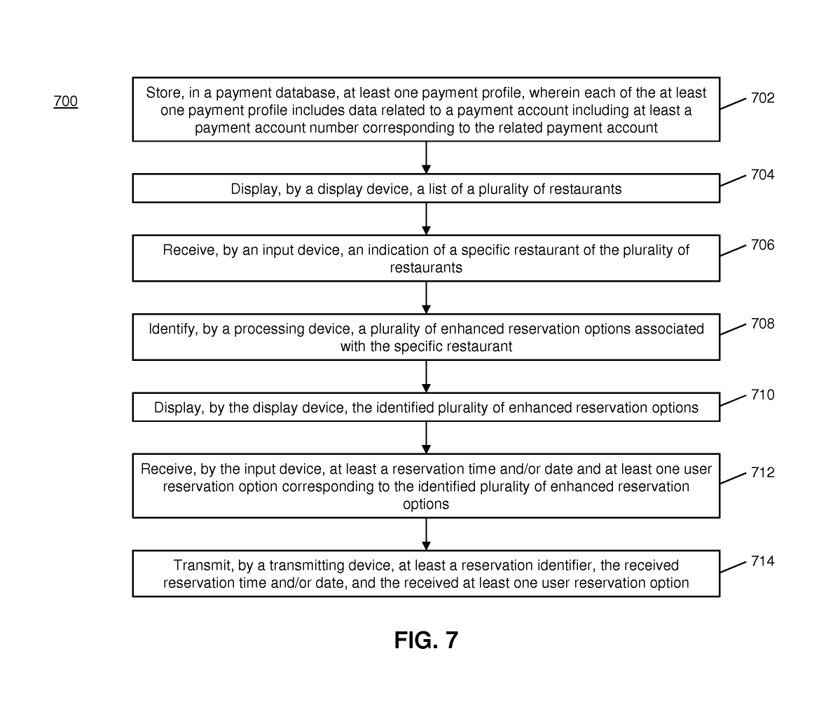

FIG. 7 illustrates a method 700 for the making of an enhanced reservation using the mobile device 104.

In step 702, at least one payment profile (e.g., the payment profile 210) may be stored, in a payment database (e.g., the payment database 208), wherein each of the at least one payment profile 210 includes data related to a payment account including at least a payment account number corresponding to the related payment account. In step 704, a list of a plurality of restaurants may be displayed, by a display device (e.g., the display unit 220). In step 706, an indication of a specific restaurant of the plurality of restaurants may be received, by an input device (e.g., the input unit 218).

In step 708, a plurality of enhanced reservation options associated with the specific restaurant may be identified, by a processing device (e.g., the processing unit 204). In one embodiment, step 708 may include: transmitting, by a transmitting device (e.g., the transmitting unit 206), a request for enhanced reservation options, wherein the request includes at least information identifying the specific restaurant; receiving, by a receiving device (e.g., the receiving unit 202), an option response as a response to the transmitted request; and identifying, by the processing device 204, the plurality of enhanced reservation options associated with the specific restaurant in the received option response. In some embodiments, the plurality of enhanced reservation options includes at least one of: booth seating, table seating, window seating, fireplace seating, seating preferences, booster chair preferences, high chair preferences, kids menu preferences, dietary restrictions, occasion being celebrated, and language preferences.

In step 710, the display device 220 may display the identified plurality of enhanced reservation options. In step 712, at least a reservation time and/or date and at least one user reservation option corresponding to the identified plurality of enhanced reservation options may be received, by the input device 218.

In step 714, at least a reservation identifier, the received reservation time and/or date, and the received at least one user reservation option may be transmitted, by the transmitting device 206. In one embodiment, the reservation identifier may be at least one of: a name, a computing device identifier, and a media access control address. In some embodiments, the method 700 may further include receiving, by the input device 218, the reservation identifier, wherein the reservation identifier is a name. In one embodiment, the method 700 may further include: storing, in a reservation database (e.g., the reservation database 212), a reservation data entry (e.g., the reservation data entry 214), wherein the reservation data entry 214 includes data related to a restaurant reservation including at least the specific restaurant, the reservation time and/or date, the at least one user reservation option, and the payment account number included in the at least one payment profile 210.

In some embodiments, the at least one payment profile 210 may further include a payment identifier. In a further embodiment, the method 700 may further include: displaying, by the display device 220, the payment identifier included in each of the at least one payment profiles 210, and receiving, by the input device 218, an indication of a specific payment profile 210 of the at least one payment profile 210. In an even further embodiment, the transmitting step 714 may further include transmitting the payment account number included in the indicated specific payment profile 210. In another further embodiment, the method 700 may further include: storing, in a reservation database (e.g., the reservation database 212), a reservation data entry (e.g., the reservation data entry 214), wherein the reservation data entry 214 includes data related to a restaurant reservation including at least the specific restaurant, the reservation time and/or date, the at least one user reservation option, and the payment account number included in the indicated specific payment profile 210.

### Exemplary Method for Conducting a Payment Transaction

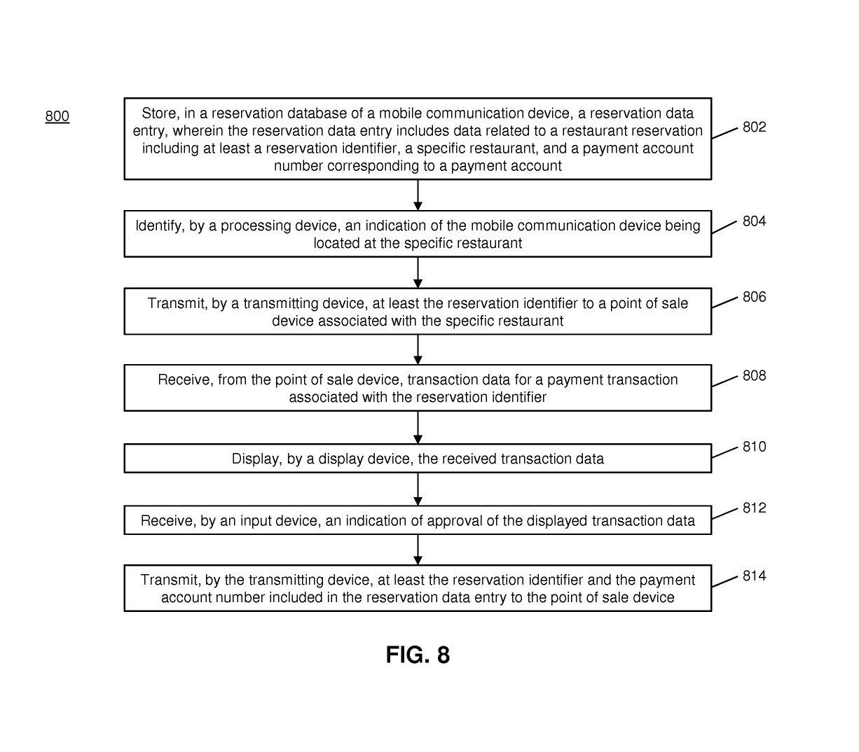

FIG. 8 illustrates a method 800 for conducting a payment transaction for an enhanced reservation using the mobile device 104.

In step 802, a reservation data entry (e.g., the reservation data entry 214) may be stored, in a reservation database (e.g., the reservation database 212) of a mobile communication device (e.g., the mobile device 104), wherein the reservation data entry 214 includes data related to a restaurant reservation including at least a reservation identifier, a specific restaurant, and a payment account number corresponding to a payment account. In one embodiment, the reservation identifier may be at least one of: a name, an identifier associated with the mobile communication device 104, an identification number, and a media access control address.

In step 804, an indication of the mobile communication device 104 being located at the specific restaurant may be identified, by a processing device (e.g., the processing unit 204). In one embodiment, step 804 may include receiving, by an input device (e.g., the input device 218), an indication from a user (e.g., the consumer 102) of the mobile communication device 104 indicating the mobile communication device 104 being located at the specific restaurant. In another embodiment, step 804 may include identifying, by the processing device 204, a geographic location of the mobile communication device 104, wherein the geographic location of the mobile communication device 104 corresponds to a location of the specific restaurant. In yet another embodiment, step 804 may include at least one of: detecting a wireless network associated with the specific restaurant, communicating with a transmitter located at the specific restaurant via near field communication, reading of a machine-readable code displayed at the specific restaurant, and receiving an aural signal emitted by a device located at the specific restaurant.

In step 806, at least the reservation identifier may be transmitted, by a transmitting device (e.g., the transmitting unit 206) to a point of sale device (e.g., the point of sale device 108) associated with the specific restaurant. In step 808, transaction data for a payment transaction associated with the reservation identifier may be received from the point of sale device 108. In step 810, the received transaction data may be displayed, by a display device (e.g., the display unit 220). In step 812, an indication of approval of the displayed transaction data may be received, by the input device.

In step 814, at least the reservation identifier and the payment account number included in the reservation data entry 214 may be transmitted by the transmitting device 206, to the point of sale device 108. In one embodiment, the indication of the approval of the displayed transaction data may include a tip amount. In a further embodiment, step 814 may further include transmitting the tip amount to the point of sale device 108. In some embodiments, the method 800 may further include displaying, by the display device 220, a request to rate the specific restaurant.

### Exemplary Method for Processing a Payment Transaction

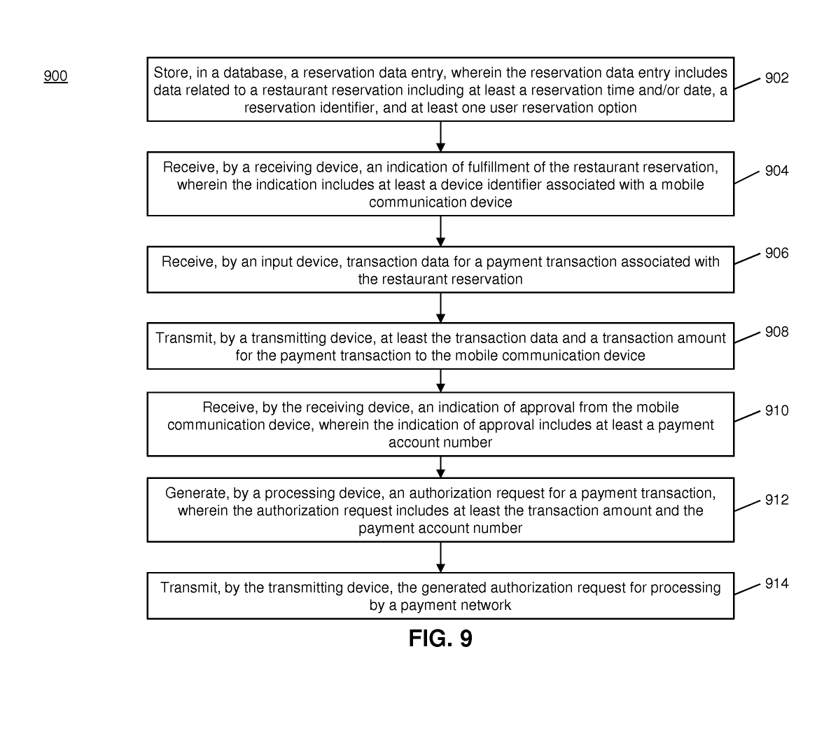

FIG. 9 illustrates a method 900 for processing a payment transaction corresponding to an enhanced reservation using the point of sale device 108.

In step 902, a reservation data entry (e.g., the reservation data entry 310) may be stored, in a reservation database (e.g., the reservation database 308), wherein the reservation data entry 310 include data related to a restaurant reservation including at least a reservation time and/or date, a reservation identifier, and at least one user reservation option. In some embodiments, the at least one user reservation option may be at least one of: booth seating, table seating, window seating, fireplace seating, seating preferences, booster chair preferences, high chair preferences, kids menu preferences, dietary restrictions, occasion being celebrated, and language preferences.

In step 904, an indication of fulfillment of the reservation may be received, by a receiving device (e.g., the receiving unit 302), wherein the indication includes at least a device identifier associated with a mobile communication device (e.g., the mobile device 104). In one embodiment, the device identifier and the reservation identifier may be the same value. In some embodiments, step 904 may include discovering, by a processing device (e.g., the processing unit 304), the mobile communication device 104 on a local area network. In one embodiment, the indication of fulfillment may originate from the mobile communication device 104.

In step 906, transaction data for a payment transaction associated with the restaurant reservation may be received, by an input device (e.g., the input unit 318). In step 908, at least the transaction data and a transaction amount for the payment transaction may be transmitted, by a transmitting device (e.g., the transmitting unit 306), to the mobile communication device 104. In step 910, an indication of approval may be received, by the receiving device 302), from the mobile communication device 104, wherein the indication of approval includes at least a payment account number.

In step 912, an authorization request for a payment transaction may be generated, by the processing device, wherein the authorization request includes at least the transaction amount and the payment account number. In one embodiment, the indication of approval may further include a tip amount, and the transaction amount included in the generated authorization request may reflect the tip amount. In step 914, the generated authorization request may be transmitted, by the transmitting unit 306, to a payment network.

### Computer System Architecture

FIG. 10 illustrates a computer system 1000 in which embodiments of the present disclosure, or portions thereof, may be implemented as computer-readable code. For example, the mobile device 104 and point of sale device 108 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 5, and 7-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 1004 may be a special purpose or a general purpose processor device. The processor 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive, the removable storage unit 1018 may be a floppy disk. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 4, 5, and 7-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for making enhanced reservations and conducting and processing payment transactions based thereon. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for making an enhanced restaurant reservation, comprising:
storing, in a payment database, at least one payment profile, wherein each of the at least one payment profile includes data related to a payment account including at least a payment account number corresponding to the related payment account;
displaying, by a display device, a list of a plurality of restaurants;
receiving, by an input device, an indication of a specific restaurant of the plurality of restaurants;
identifying, by a processing device, a plurality of enhanced reservation options associated with the specific restaurant;
displaying, by the display device, the identified plurality of enhanced reservation options;
receiving, by the input device, at least a reservation time and/or date and at least one user reservation option corresponding to the identified plurality of enhanced reservation options; and
transmitting, by a transmitting device, at least a reservation identifier, the received reservation time and/or date, and the received at least one user reservation option.

2. The method of claim 1, further comprising:
receiving, by the input device, the reservation identifier, wherein the reservation identifier is a name.

3. The method of claim 1, wherein identifying the plurality of enhanced reservation options associated with the specific restaurant includes:
transmitting, by the transmitting device, a request for enhanced reservation options, wherein the request includes at least information identifying the specific restaurant;
receiving, by a receiving device, an option response as a response to the transmitted request; and
identifying, by the processing device, the plurality of enhanced reservation options associated with the specific restaurant in the received option response.

4. The method of claim 1, wherein the plurality of enhanced reservation options includes at least one of: booth seating, table seating, window seating, fireplace seating, seating preferences, booster chair preferences, high chair preferences, kids menu preferences, dietary restrictions, occasion being celebrated, and language preferences.

5. The method of claim 1, wherein each of the at least one payment profile further includes a payment identifier, and the method further comprises:
displaying, by the display device, the payment identifier included in each of the at least one payment profiles; and
receiving, by the input device, an indication of a specific payment profile of the at least one payment profile.

6. The method of claim 5, wherein the transmitting step further includes transmitting the payment account number included in the indicated specific payment profile.

7. The method of claim 5, further comprising:
storing, in a reservation database, a reservation data entry, wherein the reservation data entry includes data related to a restaurant reservation including at least the specific restaurant, the reservation time and/or date, the at least one user reservation option, and the payment account number included in the indicated specific payment profile.

8. The method of claim 1, further comprising:
storing, in a reservation database, a reservation data entry, wherein the reservation data entry includes data related to a restaurant reservation including at least the specific restaurant, the reservation time and/or date, the at least one user reservation option, and the payment account number included in the at least one payment profile.

9. The method of claim 1, wherein the reservation identifier is at least one of: a name, a computing device identifier, and a media access control address.

10. A method for conducting a payment transaction, comprising:
storing, in a reservation database of a mobile communication device, a reservation data entry, wherein the reservation data entry includes data related to a restaurant reservation including at least a reservation identifier, a specific restaurant, and a payment account number corresponding to a payment account;
identifying, by a processing device, an indication of the mobile communication device being located at the specific restaurant;
transmitting, by a transmitting device, at least the reservation identifier to a point of sale device associated with the specific restaurant;
receiving, from the point of sale device, transaction data for a payment transaction associated with the reservation identifier;
displaying, by a display device, the received transaction data;
receiving, by an input device, an indication of approval of the displayed transaction data; and
transmitting, by the transmitting device, at least the reservation identifier and the payment account number included in the reservation data entry to the point of sale device.

11. The method of claim 10, wherein the reservation identifier is at least one of: a name, an identifier associated with the mobile communication device, an identification number, and a media access control address.

12. The method of claim 10, wherein identifying an indication of the mobile communication device being located at the specific restaurant includes:
receiving, by the input device, an indication from a user of the mobile communication device indicating the mobile communication device being located at the specific restaurant.

13. The method of claim 10, wherein identifying an indication of the mobile communication device being located at the specific restaurant includes:
identifying, by the processing device, a geographic location of the mobile communication device, wherein
the geographic location of the mobile communication device corresponds to a location of the specific restaurant.

14. The method of claim 10, wherein identifying an indication of the mobile communication device being located at the specific restaurant includes at least one of: detecting a wireless network associated with the specific restaurant, communicating with a transmitter located at the specific restaurant via near field communication, reading of a machine-readable code displayed at the specific restaurant, and receiving an aural signal emitted by a device located at the specific restaurant.

15. The method of claim 10, wherein
the indication of approval of the displayed transaction data further includes a tip amount, and
transmitting the reservation identifier and the payment account number included in the reservation data entry further includes transmitting the tip amount.

16. The method of claim 10, further comprising:
displaying, by the display device, a request to rate the specific restaurant.

17. A method for processing a payment transaction, comprising:
storing, in a database, a reservation data entry, wherein the reservation data entry includes data related to a restaurant reservation including at least a reservation time and/or date, a reservation identifier, and at least one user reservation option;
receiving, by a receiving device, an indication of fulfillment of the restaurant reservation, wherein the indication includes at least a device identifier associated with a mobile communication device;
receiving, by an input device, transaction data for a payment transaction associated with the restaurant reservation;
transmitting, by a transmitting device, at least the transaction data and a transaction amount for the payment transaction to the mobile communication device;
receiving, by the receiving device, an indication of approval from the mobile communication device, wherein the indication of approval includes at least a payment account number;
generating, by a processing device, an authorization request for a payment transaction, wherein the authorization request includes at least the transaction amount and the payment account number; and
transmitting, by the transmitting device, the generated authorization request for processing by a payment network.

18. The method of claim 17, wherein
the indication of approval further includes a tip amount, and
the transaction amount included in the generated authorization request reflects the tip amount.

19. The method of claim 17, wherein the reservation identifier and the device identifier are the same value.

20. The method of claim 17, wherein the at least one user reservation option is at least one of: booth seating, table seating, window seating, fireplace seating, seating preferences, booster chair preferences, high chair preferences, kids menu preferences, dietary restrictions, occasion being celebrated, and language preferences.

21. The method of claim 17, wherein receiving the indication of fulfillment of the reservation includes discovering, by the processing device, the mobile communication device on a local area network.

22. The method of claim 17, wherein the indication of fulfillment of the reservation originates from the mobile communication device.

23. A system for making an enhanced restaurant reservation, comprising:
a transmitting device;
a payment database configured to store at least one payment profile, wherein each of the at least one payment profile includes data related to a payment account including at least a payment account number corresponding to the related payment account;
a display device configured to display a list of a plurality of restaurants;
an input device configured to receive an indication of a specific restaurant of the plurality of restaurants; and
a processing device configured to identify a plurality of enhanced reservation options associated with the specific restaurant, wherein
the display device is further configured to display the identified plurality of enhanced reservation options,
the input device is further configured to receive at least a reservation time and/or date and at least one user reservation option corresponding to the identified plurality of enhanced reservation options, and
the transmitting device is configured to transmit at least a reservation identifier, the received reservation time and/or date, and the received at least one user reservation option.

24. The system of claim 23, wherein the input device is further configured to receive the reservation identifier, wherein the reservation identifier is a name.

25. The system of claim 23, further comprising:
a receiving device, wherein
identifying the plurality of enhanced reservation options associated with the specific restaurant includes:
transmitting, by the transmitting device, a request for enhanced reservation options, wherein the request includes at least information identifying the specific restaurant;
receiving, by a receiving device, an option response as a response to the transmitted request; and
identifying, by the processing device, the plurality of enhanced reservation options associated with the specific restaurant in the received option response.

26. The system of claim 23, wherein the plurality of enhanced reservation options includes at least one of: booth seating, table seating, window seating, fireplace seating, seating preferences, booster chair preferences, high chair preferences, kids menu preferences, dietary restrictions, occasion being celebrated, and language preferences.

27. The system of claim 23, wherein
each of the at least one payment profile further includes a payment identifier,
the display device is further configured to display the payment identifier included in each of the at least one payment profiles, and
the input device is further configured to receive an indication of a specific payment profile of the at least one payment profile.

28. The system of claim 27, wherein the transmitting device is further configured to transmit the payment account number included in the indicated specific payment profile.

29. The system of claim 27, further comprising:
a reservation database configured to store a reservation data entry, wherein the reservation data entry includes data related to a restaurant reservation including at least the specific restaurant, the reservation time and/or date, the at least one user reservation option, and the payment account number included in the indicated specific payment profile.

30. The system of claim 23, further comprising:
a reservation database configured to store a reservation data entry, wherein the reservation data entry includes data related to a restaurant reservation including at least the specific restaurant, the reservation time and/or date, the at least one user reservation option, and the payment account number included in the at least one payment profile.

31. The system of claim 23, wherein the reservation identifier is at least one of: a name, a computing device identifier, and a media access control address.

32. A mobile communication device for conducting a payment transaction, comprising:
a reservation database configured to store a reservation data entry, wherein the reservation data entry includes data related to a restaurant reservation including at least a reservation identifier, a specific restaurant, and a payment account number corresponding to a payment account;
a processing device configured to identify an indication of the mobile communication device being located at the specific restaurant;
a transmitting device configured to transmit at least the reservation identifier to a point of sale device associated with the specific restaurant;
a receiving device configured to receive, from the point of sale device, transaction data for a payment transaction associated with the reservation identifier;
a display device configured to display the received transaction data; and
an input device configured to receive an indication of approval of the displayed transaction data, wherein
the transmitting device is further configured to transmit at least the reservation identifier and the payment account number included in the reservation data entry to the point of sale device.

33. The system of claim 32, wherein the reservation identifier is at least one of: a name, an identifier associated with the mobile communication device, an identification number, and a media access control address.

34. The system of claim 32, wherein identifying an indication of the mobile communication device being located at the specific restaurant includes:
receiving, by the input device, an indication from a user of the mobile communication device indicating the mobile communication device being located at the specific restaurant.

35. The system of claim 32, wherein identifying an indication of the mobile communication device being located at the specific restaurant includes:
identifying, by the processing device, a geographic location of the mobile communication device, wherein
the geographic location of the mobile communication device corresponds to a location of the specific restaurant.

36. The system of claim 32, wherein identifying an indication of the mobile communication device being located at the specific restaurant includes at least one of: detecting a wireless network associated with the specific restaurant, communicating with a transmitter located at the specific restaurant via near field communication, reading of a machine-readable code displayed at the specific restaurant, and receiving an aural signal emitted by a device located at the specific restaurant.

37. The system of claim 32, wherein
the indication of approval of the displayed transaction data further includes a tip amount, and
transmitting the reservation identifier and the payment account number included in the reservation data entry further includes transmitting the tip amount.

38. The system of claim 32, wherein the display device is further configured to display a request to rate the specific restaurant.

39. A system for processing a payment transaction, comprising:
a processing device;
a database configured to store a reservation data entry, wherein the reservation data entry includes data related to a restaurant reservation including at least a reservation time and/or date, a reservation identifier, and at least one user reservation option;
a receiving device configured to receive an indication of fulfillment of the restaurant reservation, wherein the indication includes at least a device identifier associated with a mobile communication device;
an input device configured to receive transaction data for a payment transaction associated with the restaurant reservation; and
a transmitting device configured to transmit at least the transaction data and a transaction amount for the payment transaction to the mobile communication device, wherein
the receiving device is further configured to receive an indication of approval from the mobile communication device, wherein the indication of approval includes at least a payment account number,
the processing device is configured to generate an authorization request for a payment transaction, wherein the authorization request includes at least the transaction amount and the payment account number, and
the transmitting device is further configured to transmit the generated authorization request for processing by a payment network.

40. The system of claim 39, wherein
the indication of approval further includes a tip amount, and
the transaction amount included in the generated authorization request reflects the tip amount.

41. The system of claim 39, wherein the reservation identifier and the device identifier are the same value.

42. The system of claim 39, wherein the at least one user reservation option is at least one of: booth seating, table seating, window seating, fireplace seating, seating preferences, booster chair preferences, high chair preferences, kids menu preferences, dietary restrictions, occasion being celebrated, and language preferences.

43. The system of claim 39, wherein receiving the indication of fulfillment of the reservation includes discovering, by the processing device, the mobile communication device on a local area network.

44. The system of claim 39, wherein the indication of fulfillment of the reservation originates from the mobile communication device.
